(19) United States
(12) Patent Application Publication
(10) Pub. No.: US 2005/0257809 A1
(43) Pub. Date: Nov. 24, 2005

(54) Method and apparatus for removing substances from solid matrix with energy saving

(75) Inventors: Fortunato Fedegari, Pavia (IT); Andrea Scullino, Milano (IT); Paolo Pallado, Padova (IT)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: Fedegari Autoclavi Spa

(21) Appl. No.: 10/523,915

(22) PCT Filed: Aug. 6, 2002
(86) PCT No.: PCT/IT02/00521

§ 371 Date: Feb. 7, 2005

(51) Int. Cl. B08B 7/04; B08B 3/04

(52) U.S. Cl. 134/10; 134/105; 134/104.2

(57) ABSTRACT

A method and apparatus for washing solid matrices such as swarf from machining operations, bottles or other containers, contaminated with lubricating oils or similar substances, are described. The method is implemented with liquid CO₂ which dissolves the organic substances and is then separated therefrom by evaporation; the evaporated CO₂ is then compressed and condensed in order to recommence the cycle. An advantage of the method and apparatus is that some of the heat supplied to the CO₂ for its evaporation and some of that removed for its condensation are obtained by providing for an exchange of heat between the evaporator and the condenser of the system.

The invention relates to the removal of substances such as oils, greases, lubricants, or particulates in general from solid matrices.

As is known, increasing sensitivity to the effects produced by waste and industrial processes on the environment leads to an ever greater need to separate the above-mentioned substances from the solid matrices on which they are deposited, for disposal or recovery. These matrices are material substrates in general that are impregnated with oil, grease or the like, such as, for example, the turnings resulting from turning operations, which are contaminated by the lubricant liquid used in the cutting operations; in these circumstances, it is necessary to separate the lubricant from the turnings in order to be able to send each of them to subsequent disposal and recovery stages.

A similar situation arises with empty engine-oil containers made of recyclable plastics material. In this connection, U.S. Pat. No. 5,711,829 in the name of Smith et al. describes a method of removing the residual oil present inside the respective packages to permit recovery of the oil as well as of the plastics material.

This method is based on the use of carbon dioxide in the liquid or supercritical state, whose solvent properties with respect to organic substances such as engine oils or other types of oil, have been well known and utilized in many applications for some time.

The method of the above-mentioned American patent is substantially similar to that used for the extraction of essential oils, natural aromas, or other substances (for example caffeine) from seeds, plants, etc.; it provides for the fluid solvent in liquid or supercritical phase, at a temperature of between 20° C. and 35° C., to come into contact with the bodies or materials to be treated, which are arranged in a suitable treatment chamber or pressurized container for this purpose.

The carbon dioxide with the organic substances dissolved therein is then expanded and treated thermally so as to create, in a container disposed downstream known as a separator, a liquid phase containing the above-mentioned substances, and a gaseous CO₂ phase; the former collects in the bottom of the container, from which it is then evacuated in order to recover the substances, and the latter is liquefied by compression and cooled before returning to the washing chamber in order to pass over the bodies present therein again.

An important problem relating to the implementation of these known methods consists in effectively removing the substances from the solid matrices, whilst at the same time limiting the energy consumption which is necessary to achieve this result.

This problem has not been addressed satisfactorily in the prior art in general, which instead has concentrated mainly on seeking the best method of separating or removing the desired substances, for example, with the use of additives or other co-solvents, together with CO₂.

The present invention proposes to solve the above-mentioned problem; it therefore has the object of devising a method of removing and separating substances from a solid matrix by means of a gaseous fluid in liquid or even supercritical phase, wherein the mechanical work performed on the fluid in order to compress it can be exploited in an improved manner.

This object is achieved by a method in which the heat of condensation (or apart of it) yielded by the fluid in one stage of the operative cycle is used as heat for evaporating the fluid in another stage.

This permits, on the one hand, to cool the operating fluid after its compression during the operating cycle, and on the other hand, to heat it after expansion, by a mutual exchange of heat.

The features of the method according to the invention and of apparatus for implementing it are set forth in the claims appended to this description; the invention also comprises a heat exchanger intended for the above-mentioned apparatus.

These features will be better understood in the light of the description given below, relating to a non-limiting embodiment of a cycle for the removal and separation of the lubricant from swarf from machining operations such as turning and the like.

This embodiment is illustrated in the drawings, wherein:

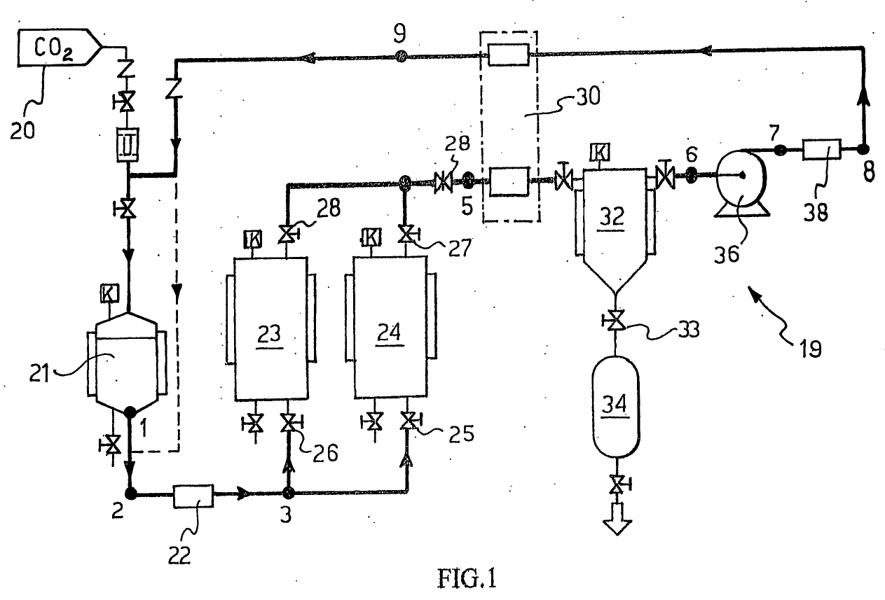

FIG. 1 shows schematically an apparatus for the removal and separation of the lubricant,

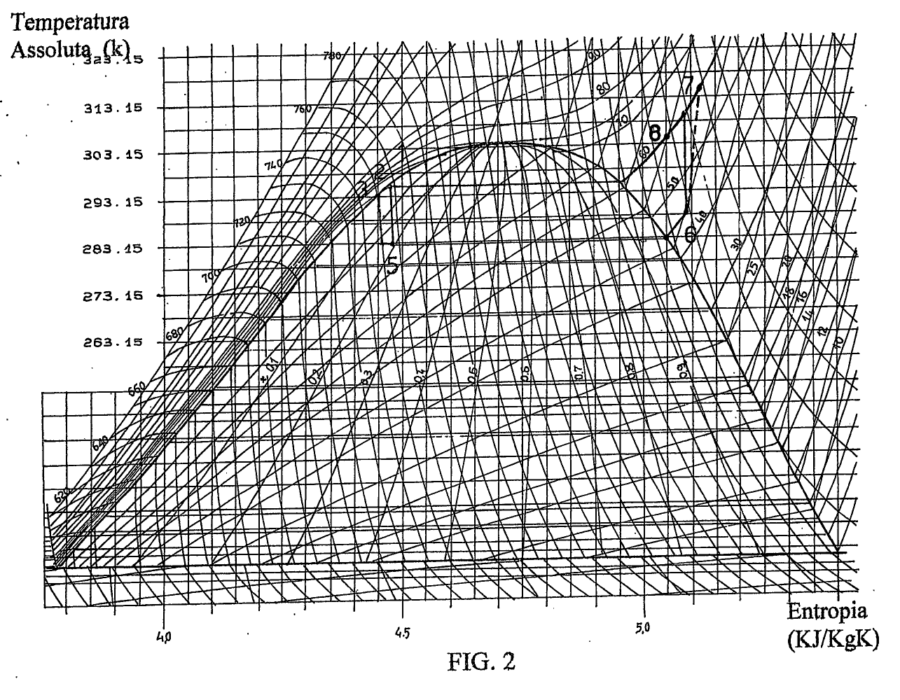

FIG. 2 is a thermodynamic representation of the operating cycle performed by the apparatus of FIG. 1, and

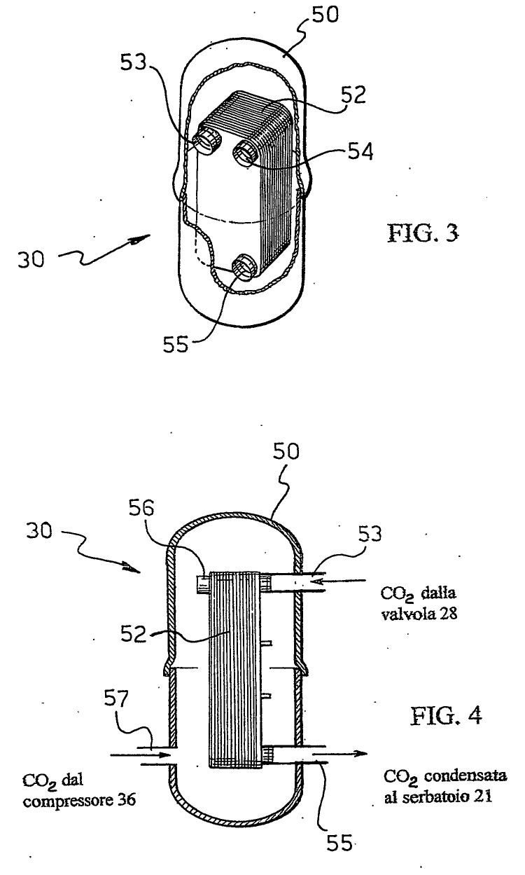

FIGS. 3 and 4 show a heat exchanger for implementing a stage of the above-mentioned cycle.

The diagram of FIG. 1 shows an apparatus 19 for removing lubricating oil from swarf and the like by means of liquid or supercritical carbon dioxide, from which the oil is also separated for recovery or disposal; the apparatus can be connected to an external source 20 of liquid CO₂ for the topping-up which is necessary to keep a constant quantity thereof in circulation.

To facilitate an understanding of the operative stages of which the operating cycle of this embodiment is composed, in addition to the main components of the apparatus, a series of points 1 to 9 which identify the starts and finishes of the stages, are also indicated in the diagram of FIG. 1.

The apparatus 19 comprises a reservoir 21 for the storage of liquid CO₂ in equilibrium with its vapour, at a pressure of from 50-70 bar (preferably about 65 bar); the base of the reservoir, from which the carbon dioxide which circulates through the apparatus emerges, coincides with the starting point 1 of the cycle.

Downstream of the reservoir 21, there is a heat-exchanger 22 for supercooling the CO₂; this exchanger is of known type and serves basically to keep the liquid carbon dioxide in temperature conditions of between 15° C. and 30° C., eliminating the presence of any gaseous phase therein, so as to permit greater efficiency of the extraction process.

However, if the apparatus were in a low-temperature environment suitable for achieving the same effect, the exchanger 22 would be superfluous and could therefore be eliminated.

In the diagram of FIG. 1, the supercooling stage takes place between points 2 and 3, and the stage of the removal or extraction of the lubricating oils from the swarf takes place between points 3 and 4, and involves two containers 23 and 24.

These containers contain the swarf to be treated and, since shut-off valves 25, 26, 27 and 28 are disposed upstream and downstream of them, it is possible, in the apparatus 19, to exclude one or other of the containers 23, 24 from the circulating CO₂ stream.

It is thus possible, whilst extracting the lubricant from the swarf in one of the containers, to empty and then refill the other container, so as to make optimal use of the apparatus.

Downstream of the containers 23 and 24 there is an expansion valve 28, for allowing the CO₂ to expand with a substantially isoenthalpic transformation to a pressure value of between 40 and 55 bar (preferably 50 bar); this expansion, which takes place between points 4 and 5 in the diagram of FIG. 1, is followed by a stage of heating of the CO₂ in an exchanger 30 which will be described in greater detail below.

After passing through the exchanger 30, the carbon dioxide and the lubricating oil form a gaseous phase and a liquid phase, respectively, which are separated in a cyclone 32.

Here, the oil is deposited at the bottom, from where it is then evacuated by means of a valve 33 and a depressurizing container 34, whilst the gaseous CO₂ continues towards a compressor 36.

The compressor brings the CO₂ back to a pressure level of between 50 and 70 bar; the compression stage takes place between points 6, 7 of FIG. 1 and, in accordance with this embodiment of the invention, is followed by de-superheating (between points 7 and 8) of the compressed gas, brought about by an exchanger 38 similar to that disposed downstream of the reservoir 21.

The exchanger 38 enables the temperature of the gaseous CO₂ to be reduced before it is condensed; in fact, as can be seen from the Mollier diagram shown in FIG. 2, which gives the entropy (in kj/kgK) on the abscissa and the absolute temperature (degrees Kelvin) on the ordinate, upon completion of the compression (point 7 of the cycle) it is in a superheated condition at about 313 K.

This is a technical solution which is also made to prevent a liquid phase and a gaseous phase being present between the intake (point 6) and the output (point 7).

However, in principle, the exchanger 38 could be eliminated or in any case excluded from the CO₂ cycle, since the CO₂ could be cooled along the path downstream of the compressor by exchanging heat with the outside environment in which the apparatus 19 is installed; however, this will also depend on other factors, such as the magnitude of the heat exchanges of the apparatus with the outside environment, or the time required to perform the operating cycle.

The compressed CO₂ is then condensed (from 8 to 9), by heat exchange with the liquid CO₂ which evaporates in the exchanger 30, and returns to the storage reservoir 21.

The execution of the operating cycle for the removal and separation of the lubricant from the swarf performed by the apparatus of FIG. 1 can easily be understood from the foregoing description.

Indeed, the properties of liquid or supercritical CO₂ at ambient temperature (20° C.-25° C.) as a solvent for organic substances such as lubricating oils, are well known.

By performing the washing (points 3 and 4 of the diagram of FIG. 1) of the swarf with the CO₂ coming from the reservoir 21 in these conditions, the lubricant is consequently removed from the swarf by being dissolved in the carbon dioxide, from which it can then be separated for recovery or disposal, according to requirements.

The cyclone separator 32 provided in the apparatus 19 performs this function in optimal manner, also by virtue of the heat previously received from the fluid in the exchanger 30.

Since this heat is supplied by the CO₂ itself, which condenses between points 8 and 9 of the cycle, the advantageous energy saving resulting from the reuse of the heat of condensation which would otherwise be lost, is clear.

Furthermore, the advantage over a situation in which the CO₂ were to be heated for being evaporated and its heating were performed by electrical resistors or other means which would require the supply of energy from outside, is even greater; similar remarks also apply if the CO₂ were to be condensed by an external cooling fluid.

Basically it can therefore be said that in the cycle according to the present invention, the mechanical work performed by the compressor 36 is utilized to the maximum since it serves both for circulating the CO₂ in the apparatus 19 (also overcoming the inevitable hydraulic friction) and for supplying energy to the fluid, which is utilized in the form of heat exchanged in the evaporation and condensation stages.

In this context it should be stressed that, in accordance with a preferred embodiment, the exchanger 30 is of the type with plates.

More specifically, as can be seen in FIGS. 3 and 4 which show the exchanger in a perspective (with a portion removed) and in a side view, respectively, it comprises an outer casing 50 which can withstand the maximum working pressures of the machine and which houses a set of plates 52.

This set is of the type commonly available commercially, for example, such as those produced by Mueller or Alfa-Laval, and has, on one side, three connectors 53, 54, and 55, communicating with the exterior of the casing; the first two are intended for admitting to the exchanger the CO₂ which evaporates after point 5 in the apparatus of FIG. 1, and for discharging it therefrom, respectively, whereas the third connector is for the outlet of the condensed CO₂ which is then returned to the storage reservoir 21.

On the other side of the set of plates 52, there is a fourth connector 56 from which the CO₂, compressed by the compressor 36 and entered inside the housing 50, passes; the housing 50 is in fact filled with compressed CO₂ (which is also supercooled in this embodiment) coming from point 8 of the apparatus, to which it is connected by means of a manifold 57.

The condensing CO₂ and that which is in the evaporation stage thus exchange heat with one another in the exchanger 30, along their respective paths within the set of plates 52 as in normal plate exchangers.

However, since the plates are in the casing 50 at the external compressed CO₂ pressure of 50-70 bar, the pressure of the fluid circulating inside them is compensated; by virtue of this arrangement it is thus possible, in the present invention, to use plate exchangers which would not otherwise be able to withstand the high working pressures required for this application.

It should in fact be pointed out that even the strongest plate exchangers with braze-welded plates are able to operate at working pressures somewhat lower than those indicated above for a cycle of removal and separation with CO₂.

However, they have a large heat-exchange capacity in relation to their fairly small dimensions, particularly when compared with exchangers with tube nests.

In other words, with this embodiment of the invention, in addition to the above-mentioned results in terms of energy saving, the considerable advantage that a limited space is occupied by the parts involved in the heat exchanges necessary for the execution of the cycle is achieved.

Naturally, variations of the invention with respect to the embodiment described above are possible.

In the first place, it should be pointed out that although the invention was devised for the removal and separation of lubricant from swarf from machining operations, it may also be applied in a similar or different manner to other fields.

Indeed it is clear that the same operating principles described above also apply to the extraction of substances from solid matrices other than swarf and this can be achieved with operating fluids other than carbon dioxide.

For example, the extraction of essences from plants and vegetables in general, or the removal of surface deposits and encrustations from bodies of various kinds, such as electronic or mechanical components, are hereby mentioned; the invention may also be used in connection with the separation of substances contained in liquids, and should not therefore be limited purely to solid matrices.

Within the scope of applications of this type, other process fluids may be used as alternatives to CO₂, for example, light alkanes or alkenes (up to 4 carbon atoms) or hydrofluorocarbons (HFCs).

It will be appreciated that in such circumstances, the apparatus which implements the removal cycle may also undergo modifications with respect to that of the diagram of FIG. 1.

It has already been stated above that in some situations one or both of the stages for the supercooling and the de-superheating of the CO₂ could be eliminated or by-passed; similarly, it should be pointed out that the storage reservoir 21 could also be excluded from the circulation of CO₂ when the system is in operation.

This situation is shown schematically by the broken line in FIG. 1 which, after point 9, joins the portion downstream of the reservoir 21; a variant of this type enables the flow of carbon dioxide in circulation to be kept constant once the apparatus has been started up to perform a working cycle and the initial transient stage of its operation has passed. Finally, it should be noted that, although the present invention has been described with reference to the use of CO₂ (or another gas) in the liquid phase, it could also be implemented with fluids in supercritical phase or in any case in dense phase, that is, a phase obtained by compressing gas to a very great extent in temperature conditions close to or greater than the critical temperature.

All of these variants fall within the scope of the appended claims.

1. A method for the removal of substances from a solid matrix, with an operating fluid in which the substances are soluble, comprising the steps of:
washing the solid matrix with the operating fluid in liquid or supercritical phase, so as to obtain a solution formed by the fluid with the substances dissolved therein,
expanding the solution and heating it so as to evaporate the operating fluid and separate it from the substances-dissolved therein,
compressing the evaporated fluid and cooling it to bring it back to the initial liquid or supercritical phase,
characterized in that at least some of the heat supplied to heat the solution and some of the heat removed by cooling the fluid after compression are obtained by providing for a heat exchange between the respective stages of the cycle.

2. A method according to claim 1, wherein for bringing about the heat exchange, the heating temperature of the solution is between 0° C. and 20° C., and the cooling temperature of the fluid is between 15° C. and 35° C.

3. A method according to claim 1 wherein for bringing about the heat exchange, the heating pressure of the solution is between 40 and 55 bar and the cooling pressure of the fluid is between 50 and 70 bar.

4. A method according to claim 1, wherein the operating fluid is one of the following: carbon dioxide, alkane or alkene with a number of carbon atoms less than or equal to 4, hydrofluorocarbon (HFC).

5. A method according to claim 1, wherein the step of the separation of the substances dissolved in the fluid is carried out with a cyclone separator (32), after the exchange of heat for heating the solution.

6. A method according to claim 1, wherein the solid matrix is constituted by swarf from machining operations and the substances to be removed comprise lubricating oils or similar organic substances.

7. Apparatus for carrying out the m4ethod according to claim 1, comprising a path for the movement of the operating fluid along which there are: a container (23, 24) for containing the solid matrix to be treated, a valve (28) for the expansion of the fluid, a separator (32), and a compressor (36), characterized in that it comprises a heat exchanger (30) which provides for an exchange of heat between a portion of the path of the fluid disposed between the expansion valve and the separator and a portion downstream of the compressor.

8. Apparatus according to claim 7, wherein the heat exchanger (30) is a plate-type exchanger.

9. Apparatus according to claim 8, wherein the heat exchanger (30) comprises an outer casing (50) which communicates with the path of the fluid and which houses a set of plates (52) through which the solution to be heated and the fluid to be cooled circulate.

10. Apparatus according to claim 7, wherein the separator (32) is a cyclone separator.

11. Apparatus according to claim 7, comprising at least two containers (23, 24) for containing the solid matrix to be treated, the containers being arranged in parallel along the path of the fluid so as to be used alternately in successive operating cycles.

12. A heat exchanger for the apparatus according to claim 7, comprising an outer casing (50) which houses a set of plates (52), and connecting means (53-57) for the circulation of fluids through the casing and through the set of plates.
